(19) United States
(12) Patent Application Publication
(10) Pub. No.: US 2007/0282944 A1
(43) Pub. Date: Dec. 6, 2007

(54) Sensor network system, gateway node, and method for relaying data of sensor network system

(76) Inventors: Toshiyuki Odaka, Fuchu (JP); Norihiko Moriwaki, Hachioji (JP); Minoru Ogushi, Kokubunji (JP); Koji Ara, Cambridge, MA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/723,770

(22) Filed: Mar. 22, 2007

Related U.S. Application Data
(63) Continuation of application No. 11/566,367, filed on Dec. 4, 2006.

(30) Foreign Application Priority Data
Dec. 5, 2005 (JP) 2005-350342

(51) Int. Cl. G06F 15/173

(52) U.S. Cl. 709/203

(57) ABSTRACT

Provided is a method for transferring data of a sensor network system in which communication is made with multiple sensor nodes SN1s connected via a wireless network to transmit sensing data measured by the sensor nodes SN1s to a server SNS connected via a wired network. The method includes: receiving the sensing data from each of the sensor nodes SN1s (S1); adding meaning information that corresponds to a measurement value contained in the sensing data to the sensing data (S2, S5); and transmitting the sensing data to which the meaning information is added to the server SNS (S6). Accordingly, data of the sensor nodes are efficiently used by multiple applications while effectively using a reduced resource for wireless communication.

This application is a continuation application of U.S. application Ser. No. 11/566,367, filed Dec. 4, 2006, the entirety of which is incorporated herein by reference.

### CLAIM OF PRIORITY

The present application claims priority from Japanese application JP2005-350342 filed on Dec. 5, 2005, the content of which is hereby incorporated by reference into this application.

### BACKGROUND

This invention relates to a technique of using information transmitted from a large number of sensors connected to a network.

In recent years, a network system (hereinafter, referred to as sensor network system) has been studied in which a compact electronic circuit having a wireless communication function is added to a sensor to retrieve various types of information used in the physical world into an information processor. A wide range of applications to the sensor network system are examined. For example, a technique is proposed in which biological information such as pulse, positional information, or the like is constantly monitored using the compact electronic circuit having a wireless circuit, a processor, a sensor, and a battery integrated therein, a monitoring result is transmitted to a server or the like by wireless communication, and a health status is judged based on the monitoring result.

In order to put the sensor network system into practical use, an electronic circuit (hereinafter, referred to as sensor node) having a wireless communication function, a sensor, and a power source such as a battery is required to be maintenance free for a long period of time and to continuously transmit sensing data.

Services provided on the current Internet are closed in a virtual space. The sensor network system essentially differs from the current Internet in that the sensor network system is linked to a physical space. If linkage to the physical space can be achieved, various services that depend on a situation such as time and a position can be realized. When a variety of objects existing in the physical space are connected to a network, traceability can be realized, thereby making it possible to cope with a social need for “safety” in a broad sense and a need for “efficiency” of inventory management or of office work (for example, JP 2003-122798 A).

### SUMMARY OF THE INVENTION

However, the above-mentioned conventional sensor network system has a problem in that just one sensor network system can handle outputs of the sensor node, so it is difficult for multiple sensor network systems to share information of the sensor node. In other words, the conventional sensor network system uses its own definition of how to handle the outputs of the sensor node. Accordingly, when a large number of sensor nodes are used in a huge network such as the Internet, it is necessary to standardize the definition of the outputs of the sensor nodes for all pieces of application software used in sensor network systems. However, a large amount of labor is required to make the definitions identical of the outputs of the sensor nodes in all the pieces of application software. Further, every time a new sensor node is added, it is necessary to standardize the definition of the outputs of the sensor nodes. Thus, a large amount of labor is required for the development and the maintenance of application software.

Further, to suppress power consumption of the battery to use the sensor node using wireless communication for a long period of time, it is desired to reduce time required for communication as much as possible. On the other hand, it is preferred that an output of the sensor node include detailed information in order for the multiple sensor network systems to use the output of the sensor node. If the priority is given to suppression of the power consumption and simple sensing data is transmitted, detailed information is not included in the output of the sensor node. Thus, it is difficult to use the output of the sensor node in the multiple sensor network systems. In contrast, when the sensor node adds detailed information to sensing data and transmits the sensing data as in the conventional technique, the power consumption is increased as the amount of data to be transmitted is increased, which reduces the lifetime of the battery. In addition to this, in a case where a large number of sensor nodes are used, when one sensor node performs redundant communication, the use efficiency is reduced in a limited wireless communication band.

This invention has been made to solve the above-mentioned problems, and it is therefore an object of this invention to easily use data of a sensor node in multiple applications while effectively using limited resources in wireless communication.

According to an aspect of this invention, there is provided a method for transferring data of a sensor network system in which communication is made with multiple sensor nodes connected to the sensor network system via a wireless network to transmit sensing data measured by each of the multiple sensor nodes to a server via a wired network, the method including the steps of:

receiving the sensing data from each of the multiple sensor nodes;

adding meaning information that corresponds to a measurement value contained in the sensing data to the sensing data; and

transmitting the sensing data to which the meaning information is added to the server.

Further, the method for transferring data of a sensor network system further includes the step of transmitting a command received from the server to a corresponding sensor node, and in the method, the step of transmitting to a corresponding sensor node includes the steps of:

extracting meaning information contained in the command received from the server;

retrieving a data identifier corresponding to the meaning information from a preset data conversion table; and

deleting the meaning information from the command and specifying the data identifier in the command.

Therefore, according to this invention, preset meaning information is added to sensing data received from a wireless network and then the sensing data is transmitted to a wired network, thereby making it possible to reduce the load of the wireless network where there are many restrictions on resources and improve the usability thereof. In addition, since the data is rich in information, it becomes extremely easy to use the data in a server and an application on a user computer. Further, since the sensing data stored in the server includes the meaning information added by a gateway (base station), the sensing data can easily be used from an application on the user computer without applying any process to the sensing data in the server, and the development and the maintenance of an application can easily be performed.

### BRIEF DESCRIPTION OF THE DRAWINGS

FIG. 1 is a block diagram of a sensor network system according to a first embodiment of this invention.

FIG. 2 is a functional block diagram of uplink packet conversion processing of a base station according to the first embodiment of this invention.

FIG. 3 is an explanatory diagram showing an example of a data format of a packet used in a wireless network, according to the first embodiment of this invention.

FIG. 4 is an explanatory diagram showing an example of a conversion rule table of the base station, according to the first embodiment of this invention.

FIG. 5 is an explanatory diagram showing an example of an address table of the base station, according to the first embodiment of this invention.

FIG. 6 is an explanatory diagram showing an example of a data format of a packet used in a wired network, according to the first embodiment of this invention.

FIG. 7 is an explanatory diagram showing an example of a data format of a payload included in the packet used in the wired network, according to the first embodiment of this invention.

FIG. 8 is an explanatory diagram showing an example of a monitor result of the packet used in the wired network, according to the first embodiment of this invention.

FIG. 9 is an explanatory diagram showing an example of a monitor result of the packet used in the wired network, according to the first embodiment of this invention, and shows a case in which a sensor node is added.

FIG. 10 is a functional block diagram of downlink packet conversion processing of the base station according to the first embodiment of this invention.

FIG. 11 is an explanatory diagram showing an example of a conversion rule table used for the downlink packet conversion processing of the base station according to the first embodiment of this invention.

FIG. 12 is a graph showing an example of a relationship between consumption current of the sensor node and time, according to the first embodiment of this invention.

FIG. 13 is an explanatory diagram showing an example of consumption current of each element of the sensor node according to the first embodiment of this invention.

FIG. 14 is a block diagram showing an example of management of meaning information and sensing data in a sensor network server according to the first embodiment of this invention.

FIG. 15 is a block diagram of a sensor network system according to a second embodiment of this invention.

FIG. 16 is an explanatory diagram showing an example of an address table of a base station according to the second embodiment of this invention.

### DETAILED DESCRIPTION OF THE PREFERRED EMBODIMENTS

Hereinafter, embodiments of this invention will be described with reference to the accompanying drawings.

### First Embodiment

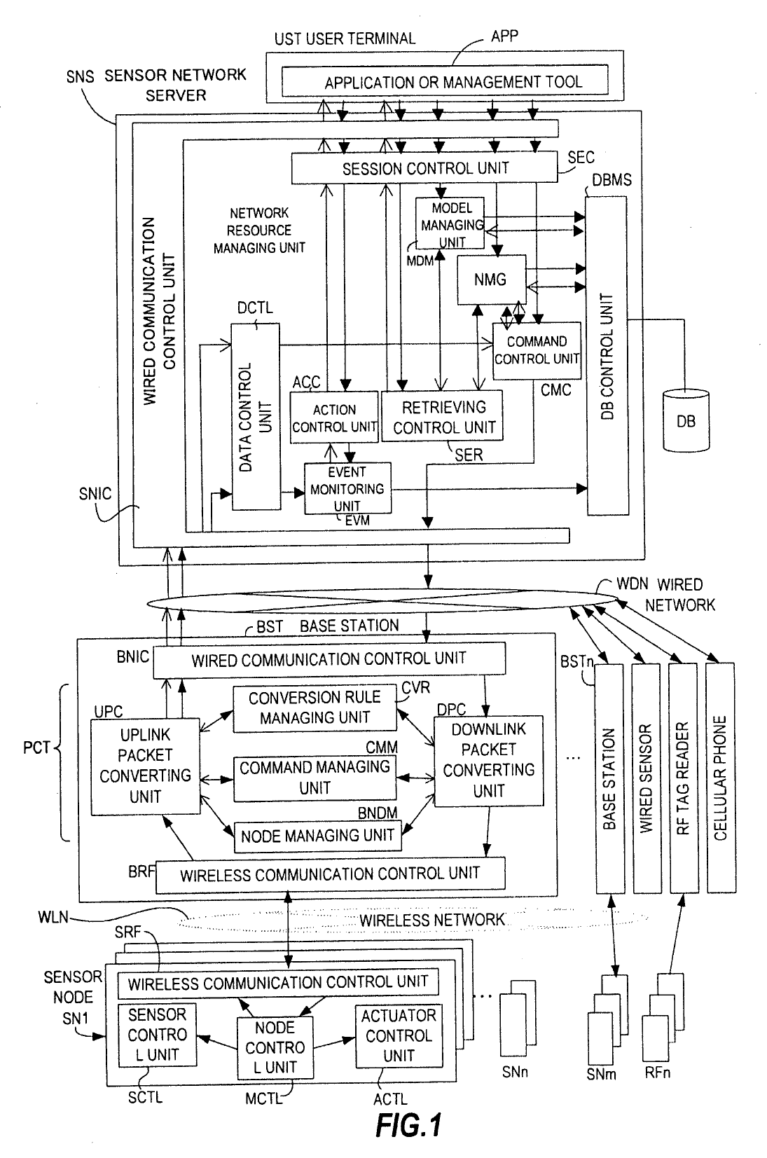

FIG. 1 is a block diagram showing an example of a sensor network system according to a first embodiment of this invention. In the sensor network system shown in FIG. 1, sensing data received from sensor nodes SN1 to SNn is transmitted to a base station BST by wireless communication. The base station BST functions as a gateway of the sensor network system to add meaning information to the sensing data. The sensing data to which the meaning information is added by the base station BST is transmitted to a sensor network server SNS via a wired network WDN and used by a user terminal UST.

(Sensor Node)

The sensor nodes SN1 to SNn shown in FIG. 1 each output sensing data or a preset identifier (ID) by wireless communication. The sensor nodes SN1 to SNn are attached, for example, to predetermined portions of a user for the purpose of monitoring a status of the user. The sensor nodes SN1 to SNn perform wireless communication with the base station BST via a wireless network WLN. Each of the sensor nodes SN1 to SNn transmits data of measured temperature, pulse, and the like to the base station BST.

The sensor nodes SN1 to SNn each include a sensor control unit SCTL for managing an operation of a sensor (not shown) provided for each of the sensor nodes SN1 to SNn, an actuator control unit ACTL for managing an operation of an actuator (not shown) provided for each of the sensor nodes SN1 to SNn, a wireless communication control unit SRF for communicating with the base station BST via the wireless network WLN, and a node control unit MCTL for controlling the sensor control unit SCTL, the actuator control unit ACTL, and the wireless communication control unit SRF.

An air conditioner is one of examples of the sensor nodes SN1 to SNn having an actuator. When the actuator is not included in the sensor nodes SN1 to SNn, the actuator control unit ACTL is not provided.

Examples of sensors provided for the sensor nodes SN1 to SNn include a temperature sensor, a humidity sensor, a pulse sensor, and other kinds of sensors having an identifier for identifying an individual person or thing.

(Base Station)

The base station BST includes a wireless communication control unit BRF for controlling wireless communication with the multiple subordinate sensor nodes SN1 to SNn, a wired communication control unit BNIC for controlling wired communication with the sensor network server SNS, and a packet control part PCT for controlling packets exchanged between the sensor network server SNS and the sensor nodes SN1 SNn.

The packet control part PCT includes: an uplink packet converting unit (first data converting unit) UPC for adding the meaning of sensing data to an uplink packet transmitted from the sensor nodes SN1 to SNn to the sensor network server SNS, according to a meaning interpretation rule (conversion rule) which is set in a conversion rule managing unit CVR; a downlink packet converting unit (second data converting unit) DPC for deleting the meaning of a command from a downlink packet transmitted from the sensor network server SNS to the sensor nodes SN1 to SNn, according to a meaning interpretation rule which is set in the conversion rule managing unit CVR, so as to reduce information of the packet; a node managing unit BNDM for managing IDs; and a command managing unit CMM for managing commands (command data) transmitted to the sensor nodes SN1 to SNn.

The conversion rule managing unit CVR serves as a meaning interpretation unit for applying conversion of the type (such as temperature or voltage) and the unit (such as ° C. or F) of a physical quantity for each packet type to sensing data transmitted from the sensor nodes SN1 to SNn, according to a preset conversion rule. For example, the conversion rule managing unit CVR generates a conversion rule by using all pieces of sensing data transmitted from all the sensor nodes SN1 to SNn, which are assumed to be used by one application. The conversion rule may be hard-coded or may be given to a program as data (for example, in the form of a text file or a table).

The command managing unit CMM manages commands transmitted by the wireless communication control unit BRF in order to judge whether uplink data transmitted from the sensor nodes SN1 to SNn to the sensor network server SNS is a response to a command that has been transmitted to the sensor nodes SN1 to SNn. When the downlink packet converting unit DPC which destines a command to the sensor nodes SN1 to SNn transmits the command to the subordinate sensor nodes SN1 to SNn, the command is registered.

The node managing unit BNDM performs conversion from a local ID to a corresponding global ID or conversion from a global ID to a corresponding local ID. Accordingly, an address table to be described later may be provided in advance, or may be updated every time the base station BST accepts participation of the sensor nodes SN1 to SNn.

The local ID is used within one personal area network (PAN). In general, one PAN includes one base station BST having a function of managing local IDs. The local ID is shorter than the global ID in bit length, so an effect is expected in which power consumption of wireless communication can be suppressed when the local ID is included in a transmission/reception packet.

The global ID can be used at least by an application on the sensor network system or an upper system of the sensor network system to identify the corresponding sensor node. Since one sensor network system may include multiple PANs, an application or an upper system of the sensor network system manages sensor nodes using the global IDs.

Thus, the number of bits of a global ID is larger than that of a local ID. For example, a global ID is basically composed of 128 bits according to the ucode of Ubiquitous ID Center or is composed of 96 bits according to the Electronic Product Code (EPC) of EPCglobal. In contrast, a local ID is composed of about 16 bits, for example.

(Sensor Network Server)

The sensor network server SNS manages sensing data collected by a plurality of base stations BST to BSTN via the wired network WDN (for example, the Internet) and provides the user terminal (user computer) UST with sensing data to which meaning information is added.

The sensor network server SNS includes: a wired communication control unit SNIC for communicating with the base station BST, a wired sensor, an RF tag reader, a cellular phone, and the user terminal UST via the wired network WDN; a data control unit DCTL for accepting a received packet; an event monitoring unit EVM for monitoring sensing data included in the received packet and causing an event; an action control unit ACC for performing a predetermined action based on the event; a DB control unit DBMS for storing sensing data, configuration information of the sensor network system, and a physical-world model table in a database DB, and performing a reference to and an update of the database DB; a model managing unit MDM for managing a relationship between a physical-world model (object) that is easy for the user to understand and the sensing data stored in the database DB; a retrieving control unit SER for retrieving, from the database DB, meaning information requested by the user terminal UST based on the model managing unit MDM; a command control unit CMC for instructing the base station BST and the sensor nodes SN1 to SNn based on a command transmitted from the user terminal UST and the like; a network resource managing unit NMG for managing configuration information of the base stations BST to BSTN and the sensor nodes SN1 to SNn; and a session control unit SEC for controlling transmission to and reception from the user terminal UST.

The data control unit DCTL transfers data transmitted from the base stations BST to BSTN and received by the wired communication control unit SNIC to the event monitoring unit EVM when the data is sensing data and to the command control unit CMC when the data is a response to a command (command data).

The event monitoring unit EVM causes an event when the received sensing data satisfies a preset condition, and notifies the action control unit ACC of the event. A condition accepted from the user terminal UST is stored as a condition for causing an event. The event monitoring unit EVM transmits the received sensing data to the DB control unit DBMS and the DB control unit DBMS stores the sensing data in the database DB.

The action control unit ACC performs a preset action corresponding to the event of which the event monitoring unit EVM notifies. The action is an operation of sending email to a preset address when the sensing data satisfies a predetermined condition, for example, and this action is set in advance in response to an instruction of the user terminal UST.

The model managing unit MDM manages the relationship between the physical-world model that is easy for the user to understand and the sensing data stored in the database DB by using a table (not shown). The model managing unit MDM identifies the sensing data corresponding to a physical-world model requested by the user terminal UST and requests the DB control unit DBMS to refer to the identified sensing data.

The network resource managing unit NMG comprehensively manages the base stations BST to BSTn connected to the wired network WDN and constituting the sensor network system, and the sensor nodes SN1 to SNn connected to a base station BSTx. The network resource managing unit NMG provides the user terminal UST and the like with an interface for registration or retrieval of a base station BST and a sensor node, and manages the status of each network resource and the status of each sensor node.

(Uplink Packet Conversion Processing of the Base Station)

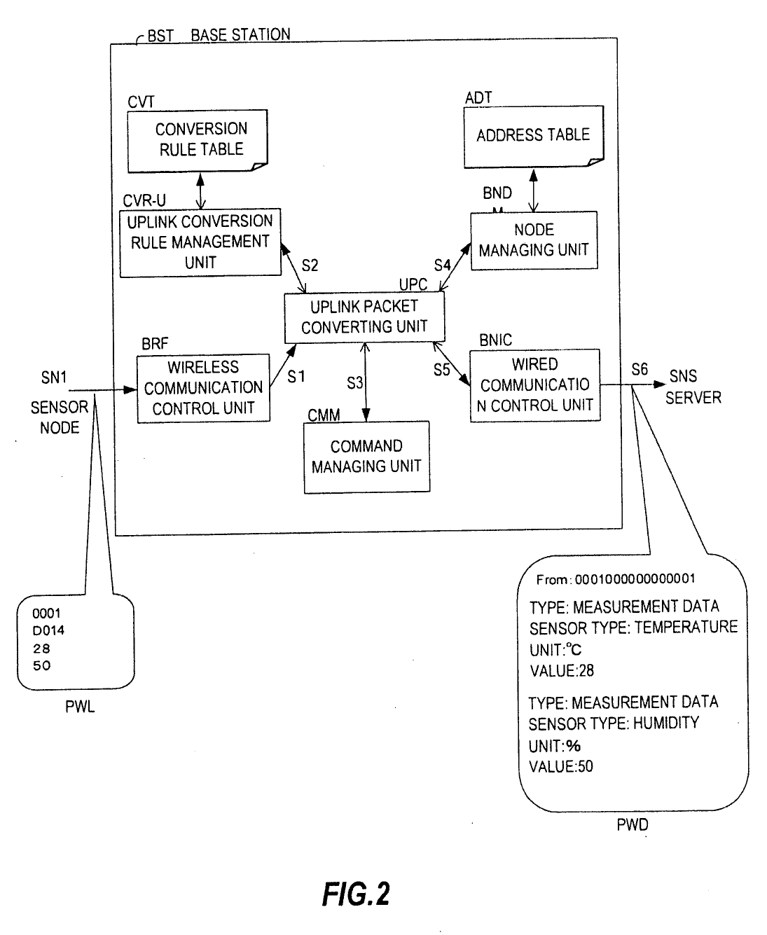

Next, referring to FIGS. 2 to 8, uplink packet communication processing performed in the base station BST will be described hereinafter. FIG. 2 shows a main part of the base station BST, which processes an uplink packet when sensing data is received from the sensor nodes SN1 to SNn.

In FIG. 2, an uplink conversion rule managing unit CVR-U is a part of the conversion rule managing unit CVR shown in FIG. 1, for processing an uplink packet. The wireless communication control unit BRF receives a packet PWL from each of the sensor nodes SN1 to SNn. The uplink packet converting unit UPC obtains information from a position preset in the received packet PWL and inquires of the uplink conversion rule managing unit CVR-U to judge the meaning of the received packet PWL. The uplink conversion rule managing unit CVR-U refers to a preset conversion rule table CVT to judge what kind of sensing data the received packet PWL includes.

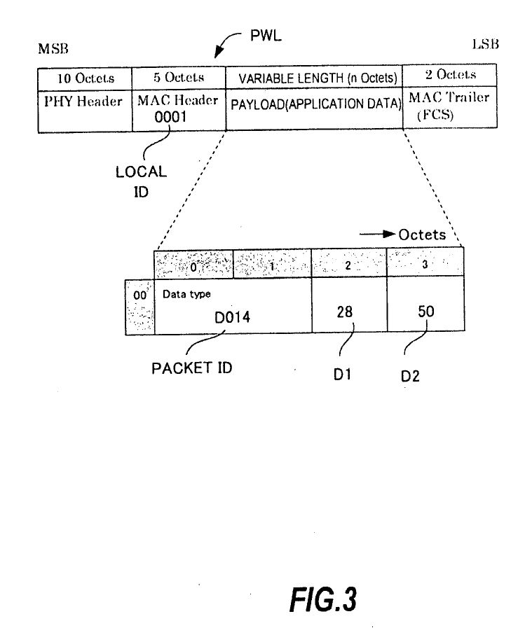

A data format of the packet PWL transmitted and received in the wireless network WLN is shown in FIG. 3, for example. The packet PWL shown in FIG. 3 has a variable length. The packet PWL includes a physical header having ten octets (bytes) from the most significant byte (MSB) of the packet PWL, a MAC header having the next five octets, a MAC trailer having two octets from the least significant byte, and a variable-length (n octets) payload between the MAC header and the MAC trailer. In this embodiment, a local ID controlled by the base station BST is set in the MAC header.

In a case where the payload has four octets (bytes), two octets on the MSB side (the 0th octet and the 1st octet) indicate a data type, in this embodiment, the type of the payload of the packet PWL. Then, the 2nd octet indicates a first data field D1 having one byte (8 bits), and the 3rd octet indicates a second data field D2 having one byte. The number of data fields and the length of each data field can be appropriately set according to the type of information and the precision of information outputted by a sensor node.

The local ID contained in the MAC header is an identifier uniquely assigned by the node managing unit BNDM to each of the sensor nodes SN1 to SNn controlled by the base station BST, and is used by the base station BST to identify each of the subordinate sensor nodes SN1 to SNn.

A packet ID (data identifier) is used to interpret the meaning of sensing data transmitted by a sensor node when there are multiple kinds of sensor nodes controlled by the base station BST. As described later, the sensor nodes SN1 to SNn each store, as the packet ID, code preset for each type of the payload.

When the base station BST receives a packet PWL from the sensor node SN1, the uplink packet converting unit UPC extracts the packet ID from the payload and makes an inquiry to the uplink conversion rule managing unit CVR-U.

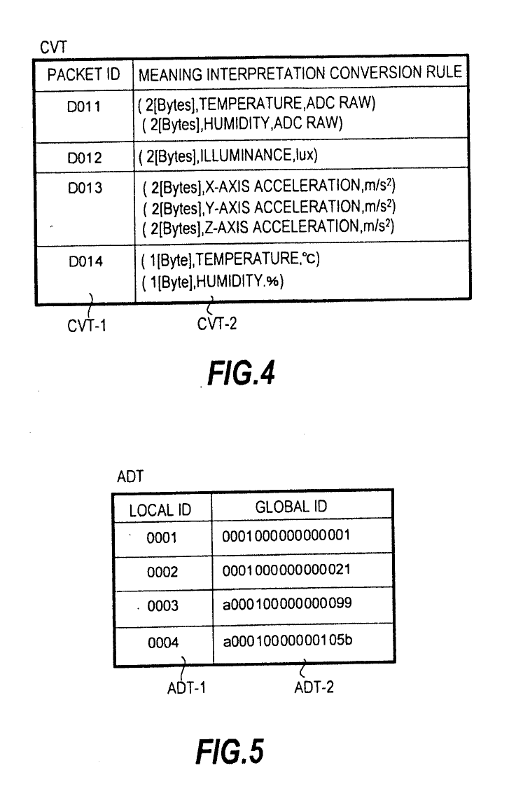

The uplink conversion rule managing unit CVR-U has the conversion rule table CVT shown in FIG. 4 in which the packet ID (CVT-1) is associated with a meaning interpretation conversion rule CVT-2 which defines the meaning of each data field included in the payload. The uplink conversion rule managing unit CVR-U searches the conversion rule table CVT using the packet ID, which indicates the type of a payload, to interpret the meaning of data stored in the data fields D1 and D2 of the packet PWL.

The example of FIG. 4 shows that there are four kinds of packets transmitted by the sensor nodes SN1 to SNn. One sensor node is provided with one to four sensors (for temperature, humidity, illuminance, and acceleration). The position, the length (the number of bytes), and the unit of sensing data of each sensor are set in the meaning interpretation conversion rule CVT-2 for each packet ID (CVT-1). In a case of a packet ID of D014, for example, it is indicated that, among the data fields of the payload, the data field of one byte includes data whose meaning is “temperature” and unit is “° C.”, and the data field of one byte following this data field includes data whose meaning is “humidity” and unit is “%”. The uplink conversion rule managing unit CVR-U can judge what meaning each data field of the received sensing data has by referring to the conversion rule table CVT.

For example, as shown in FIG. 2, when the contents of the payload of the packet PWL received from the sensor node SN1 include D014, 28, and 50, the uplink packet converting unit UPC extracts, as a packet ID, the data of “D014” having 16 bits at the 0th octet and the 1st octet, and makes an inquiry to the uplink conversion rule managing unit CVR-U. The uplink conversion rule managing unit CVR-U searches packet IDs included in the conversion rule table CVT for “D014”, and notifies the uplink packet converting unit UPC that the data field at the 1st byte (octet) includes meaning information of “temperature” and a unit of “° C.”, and the data field at the 2nd byte includes meaning information of “humidity” and a unit of “%”.

Upon reception of a notification of the contents of the data fields from the uplink conversion rule managing unit CVR-U, the uplink packet converting unit UPC generates a packet in which the data type, the meaning information, and the unit are added in the respective data fields based on the notification. In a case of an uplink packet, the data type is an identifier indicating that the payload is either sensing data or a response to a command. The uplink packet converting unit UPC inquires of the command managing unit CMM whether the data in question is a response to a command that has been issued. When the command managing unit CMM transmits an answer indicating that the data of inquiry is a response to the command to the uplink packet converting unit UPC, the uplink packet converting unit UPC judges that the data of inquiry is a response to the command and sets the data type to “command response”.

Next, the uplink packet converting unit UPC converts the local ID contained in the MAC header, serving as an identifier controlled by the base station BST, to a corresponding global ID serving as an identifier used on the sensor network system. The uplink packet converting unit UPC extracts the local ID from the MAC header and inquires of the node managing unit BNDM about a global ID corresponding to the local ID.

As shown in FIG. 5, the node managing unit BNDM refers to a preset address table ADT and notifies the uplink packet converting unit UPC of the global ID. The global ID is determined by the network resource managing unit NMG of the sensor network server SNS and notified to each of the base stations BST to BSTn.

Upon acquisition of the data type, the meaning information of the sensing data, the unit, and the global ID, the uplink packet converting unit UPC generates a packet PWD to be transmitted to the wired network WDN.

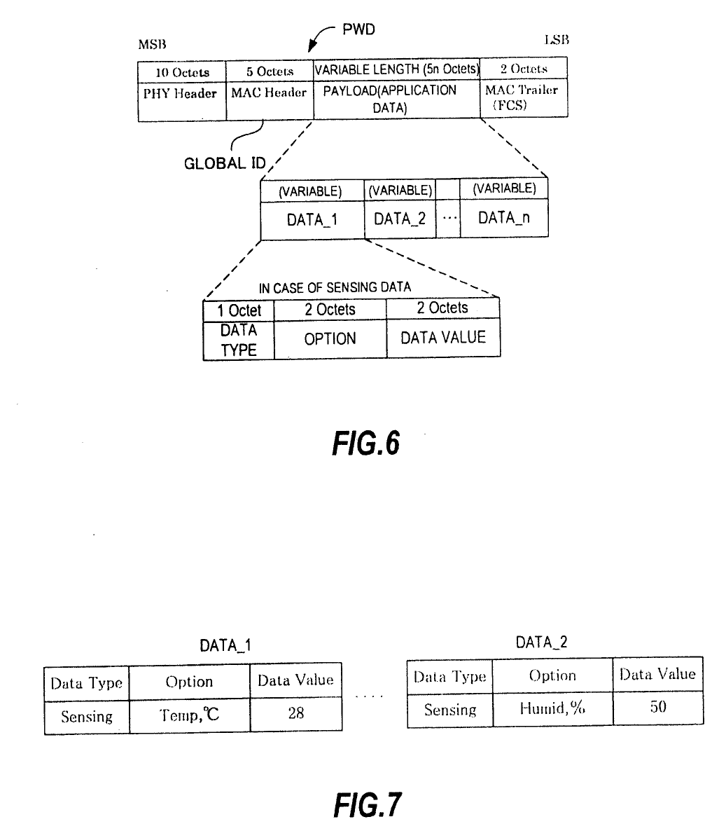

FIG. 6 shows an example of a data format of the packet PWD transmitted and received in the wired network WDN. In the example of FIG. 6, the payload has a variable length.

The packet PWD includes a physical header having ten octets (bytes) from the most significant byte (MSB) of the packet PWD, a MAC header having the next five octets, a MAC trailer having two octets from the least significant byte, and a variable-length (n octets) payload between the MAC header and the MAC trailer. In this embodiment, a global ID serving as a unique identifier on the sensor network system is set in the MAC header.

In the payload, when one piece of data is expressed by five octets (bytes), the 1st octet on the MSB side indicates the data type in which an identifier indicating either sensing data or a command is set. Then, two bytes (16 bits) of the 2nd and 3rd octets indicate an option field in which information on the type and the unit system of sensing data is set. Two bytes of the 4th and 5th octets indicate a data value field for storing the value of sensing data, in which the value of the data field D1 or the like constituting the packet PWL for the wireless zone can be set. In the payload of a packet PWD for the wired network WDN, multiple (n) pieces of data having the above-mentioned five octets can be stored.

The packet PWL for the wireless zone, as shown in FIGS. 2 and 3, which includes sensing data transmitted from the sensor node SN1 is converted into a packet PWD for the wired zone, as shown in FIG. 7, with the data type, the meaning information, and the unit to the packet PWL added by the uplink packet converting unit UPC of the base station BST, and is transmitted to the sensor network server SNS by the wired communication control unit BNIC.

For example, the data of the packet PWL of FIG. 2 transmitted from the sensor node SN1, which includes D014, 28, and 50, is judged from the information of the packet ID of D014 by the uplink conversion rule managing unit CVR-U that two physical quantities, i.e., temperature and humidity, each having one byte are contained and their units are ° C. and %.

The uplink packet converting unit UPC stores a value of “28” of the first data field D1 extracted from the packet PWL for the wireless network WLN in the data value field which constitutes a first data unit DATA_1 of FIG. 7 included in the packet PWD for the wired network WDN, and stores data (or code) indicating the type of the physical quantity, “temperature”, and the unit thereof, “° C.”, in an option field based on the judgment result. Then, the uplink packet converting unit UPC stores a value indicating “sensing data” in the data type field.

Subsequently, the uplink packet converting unit UPC stores a value of “50” of the second data field D2 extracted from the packet PWL for the wireless network WLN in the data value field which constitutes a second data unit DATA_2 of FIG. 7 included in the packet PWD for the wired network WDN, and stores data (or code) indicating the type of the physical quantity, “humidity”, and the unit thereof, “%”, in the option field based on the judgment result. Then, the uplink packet converting unit UPC stores a value indicating “sensing data” in the data type field. The uplink packet converting unit UPC stores a value of the global ID converted from the local ID in the MAC header, whereby assembling the packet PWD for the wired network WDN.

The processing for an uplink packet performed by the base station BST as described above is summarized as follows. In FIG. 2, upon reception of a packet PWL from the sensor nodes SN1 to SNn, the wireless communication control unit BRF transmits the packet PWL to the uplink packet converting unit UPC (S1).

The uplink packet converting unit UPC extracts a packet ID from the packet PWL and inquires of the uplink conversion rule managing unit CVR-U about the meaning information of sensing data. The uplink conversion rule managing unit CVR-U refers to the conversion rule table CVT and transmits the meaning information corresponding to the packet ID to the uplink packet converting unit UPC as a response (S2).

The uplink packet converting unit UPC inquires of the command managing unit CMM whether the packet ID indicates a response to a command (S3).

Next, in order to convert the packet PWL for the wireless zone into a packet PWD for the wired zone, the uplink packet converting unit UPC transmits the local ID to the node managing unit BNDM to inquire of the node managing unit BNDM about a corresponding global ID (S4). Upon reception of the global ID, the uplink packet converting unit UPC sets, in a case where the packet PWL for the wireless zone is sensing data, “sensing data” in the data type field. Then, the uplink packet converting unit UPC stores meaning information (the type and the unit system of a physical quantity) and a value of data in the payload of the packet PWD for the wired zone as a series of data, and stores the global ID in the MAC header of the packet PWD for the wired zone, whereby assembling the packet PWD (S5). Upon completion of the assembling of the packet PWD, the uplink packet converting unit UPC sends the packet PWD to the wired communication control unit BNIC to transmit the packet PWD to the sensor network server SNS (S6).

Therefore, simple information that includes sensing data such as 28 and 50, the packet ID, and the local ID is transmitted from the sensor nodes SN1 to SNn to the base station BST. The base station BST obtains meaning information (the type and the unit system of a physical quantity) which can be used in the sensor network server SNS from the packet ID and identifies what type of sensing data the payload of the simple packet PWL for the wireless zone is. The type and the unit system of a physical quantity of the sensing data are added to the sensing data to process it into meaningful information, and then the resultant data is transmitted to the sensor network server SNS.

As described above, the base station BST configures a packet PWL transmitted and received in the wireless zone, where restriction on resources such as the bandwidth is strict, by the sensing data and an identifier (packet ID) that determines the meaning information of the sensing data, so the load of transmission of the packet PWL for the wireless network WLN is suppressed, thereby improving the usability of the wireless network WLN. On the other hand, in the wired network WDN in which restriction on resources is relatively loose, meaning information is added to a packet PWL received from the wireless network WLN to provide the sensor network server SNS with the data which can be easily used, thereby making it possible to use sensing data obtained from one sensor node by multiple applications.

(Processing of the Sensor Network Server SNS)

When the sensor network server SNS receives the packet PWD from the base station BST via the wired network WDN, the data control unit DCTL extracts the data type from the payload of the packet PWD. When the data type is “sensing data”, the data control unit DCTL of FIG. 1 transmits the packet PWD to the event monitoring unit EVM in which whether to cause an event is judged.

The event monitoring unit EVM reads an event condition from an event table (not shown) which is made based on the global ID, for respective data units DATA_1 to DATA_n of the packet PWD, to make a judgment of an event. This event condition includes content, for example, in which when the global ID is 001000000000001 and the temperature exceeds 25° C., an event assigned with a predetermined event ID is notified.

When the event monitoring unit EVM causes an event, the event monitoring unit EVM notifies the action control unit ACC of the event. The action control unit ACC has an action table (not shown) which defines a process to be performed for each event ID and performs a process corresponding to a received event ID. In the action table, there is specified a process, for example, in which when the event ID is a predetermined ID, email indicating that the temperature exceeds a threshold is sent to an address A. When a received event ID is found in the action table, the action control unit ACC performs a corresponding specified process.

After the judgment of an event, the event monitoring unit EVM stores the global ID and the payload of the received packet PWD in the database DB in association with each other. In other words, the base station BST adds meaning information to the packet PWL transmitted from the sensor nodes SN1 to SNn to convert the packet PWL into the packet PWD for the wired network WDN so that the sensor network server SNS can store the received packet PWD in the database DB as it is. If a global ID is known, the DB control unit DBMS can retrieve sensing data that includes meaning information as needed.

A global ID is necessary to use sensing data from the user terminal UST connected to the sensor network server SNS. However, it is extremely difficult for the user to identify the global ID. The model managing unit MDM shown in FIG. 1 can easily retrieve sensing data desired by the user from an enormous amount of sensing data by associating the meaning that can be understood by the user with the global ID of the sensing data.

The model managing unit MDM has the physical-world model table (described later) in which a global ID is associated in advance with the meaning of sensing data. For example, a global ID of 001000000000001 is associated with the meaning of “conference room A: temperature, humidity”. Accordingly, when the user terminal UST makes a request for “conference room A: temperature, humidity” to the model managing unit MDM, the model managing unit MDM refers to the DB control unit DBMS for the sensing data of the global ID of 001000000000001. The DB control unit DBMS returns the payload read from the database DB based on the global ID to the model managing unit MDM. The model managing unit MDM transmits a value of 28 whose meaning information is temperature and unit is ° C. and a value of 50 whose meaning information is humidity and unit is % to the user terminal UST as a response. With this operation, the sensor network server SNS can respond to a reference request of the user terminal UST without applying any process to the stored payload.

Further, when sensing data stored in the database DB is used from an application APP on the user terminal UST, the development and the maintenance of the application APP can easily be performed since the type and the unit of a physical quantity are added to each piece of the sensing data.

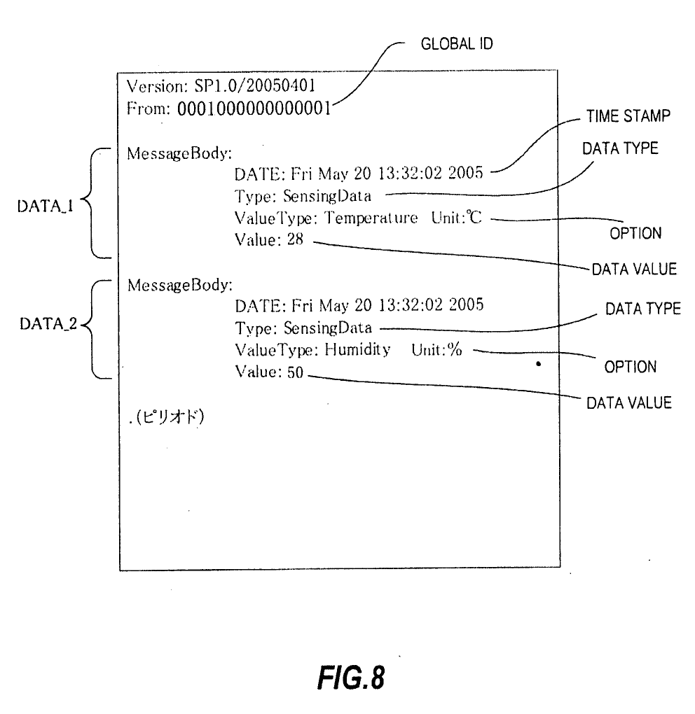

For example, the sensing data shown in FIG. 7 of the sensor node SN1 that is provided with a temperature sensor and a humidity sensor has meaning information added by the base station BST, so when the packet PWD received by the sensor network sever SNS is monitored, two messages are included as shown in FIG. 8. The first message corresponds to the data unit DATA_1 of FIG. 7 constituting the packet PWD, in which a time stamp and the data value contained in the data field D1 which are set by the sensor node SN1 and the type (temperature) and the unit (° C.) of a physical quantity contained in the option field and the data type which are added by the base station BST can be seen. The second message corresponds to the data unit DATA_2 constituting the packet PWD in which a time stamp and the data value contained in the data field D2 which are set by the sensor node SN1 and the type (humidity) and the unit (%) of a physical quantity contained in the option field and the data type which are added by the base station BST can be seen.

As described above, the base station BST adds meaning information to the packet PWD for the wired network WDN side, thereby making it extremely easy to perform data processing in the sensor network server SNS side. In addition, the packet PWL for the wireless zone has a simple configuration having a short data length (small amount of data), thereby enabling shortening of the communication period and suppression of the consumption of batteries used in the sensor nodes SN1 to SNn.

Further, since meaning information is added by the base station BST, the load of the sensor network server SNS can be suppressed when the sensor network server SNS handles an enormous number of sensor nodes SN1 to SNn. In other words, if sensing data of the sensor nodes SN1 to SNn is sent to the sensor network server SNS as it is and the sensor network server SNS adds meaning information to the sensing data, an excessive process load of adding meaning information is imposed on the sensor network server SNS, which leads to a delay in response to the user terminal UST and the like.

Thus, sensing data of the sensor nodes SN1 to SNn is processed and meaning information is added to the sensing data in the base station BST, so storing of sensing data, retrieval by the model managing unit MDM, monitoring of an event, a process with respect to a request from the user terminal UST, and the like can be reliably performed in the sensor network server SNS.

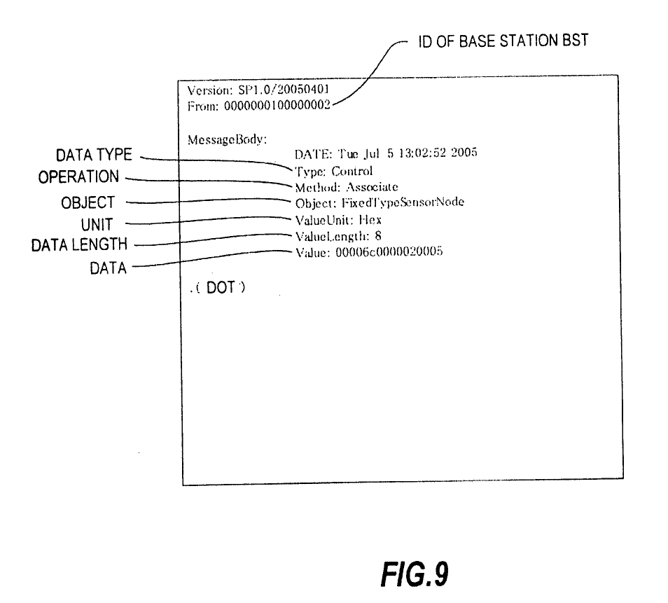

With reference to FIGS. 2 to 8, description is made above of the example in which the sensor nodes SN1 to SNn transmit sensing data. FIG. 9 shows an example of a packet PWD for the wired network WDN, obtained when a new sensor node to be controlled by the base station BST is added. It should be noted that FIG. 9 shows the packet PWD, monitored by the sensor network server SNS.

FIG. 9 shows that, in the packet PWD transmitted by the base station BST to the sensor network server SNS via the wired network WDN, a control command (Control) is stored as the data type, a connection request (Associate) is stored as an operation instruction, the operation object is a fixed type sensor node, the data unit is hexadecimal, the data length is 8 bytes, and the data value is 0006c0000020005. The data format of the packet PWD is defined in advance for control commands, which differs from that of sensing data of FIGS. 6 and 7.

(Downlink Packet Conversion Processing of the Base Station)

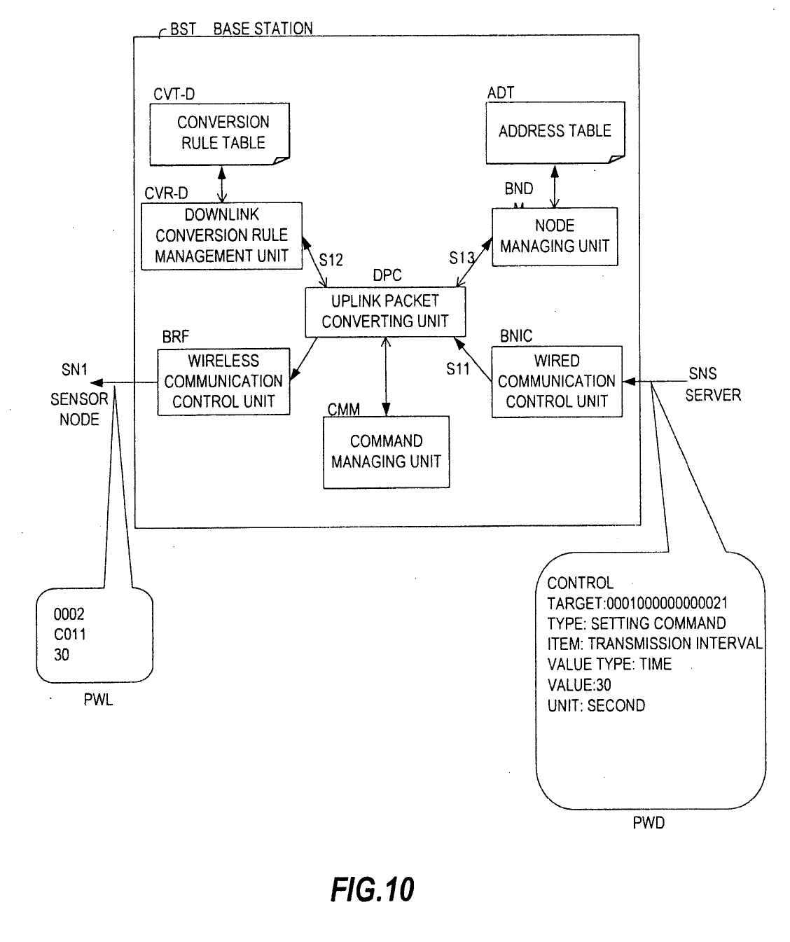

Next, referring to FIGS. 10 to 13, conversion processing for a downlink packet transmitted from the base station BST to the sensor nodes SN1 to SNn will be described hereinafter.

In FIG. 10, a downlink conversion rule managing unit CVR-D is a part of the conversion rule managing unit CVR shown in FIG. 1, for processing a downlink packet. The wired communication control unit BNIC receives a packet PWD from the sensor network server SNS via the wired network WDN. The downlink packet converting unit DPC obtains information (data type) from a position preset in the received packet PWD and inquires of the downlink conversion rule managing unit CVR-D to judge the meaning of the received packet PWD.

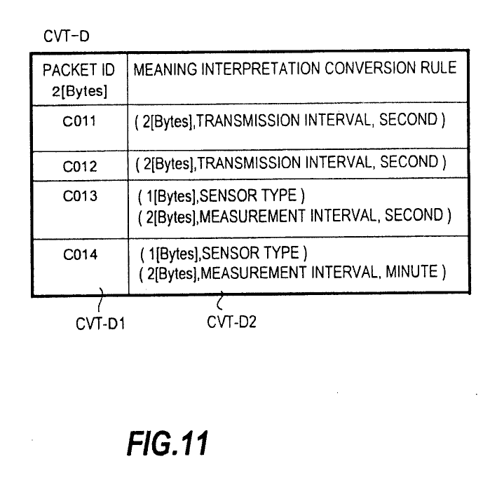

As shown in FIG. 11, the downlink conversion rule managing unit CVR-D refers to a preset conversion rule table CVT-D to judge the packet ID corresponding to the received packet PWD for the wired network WDN, the packet ID being specified in a packet PWL for the wireless zone.

The downlink conversion rule managing unit CVR-D has the conversion rule table CVT-D shown in FIG. 11 in which the packet ID (CVT-D1) is associated with a meaning interpretation conversion rule CVT-D2 which defines the meaning of each data field included in the payload. The downlink conversion rule managing unit CVR-D searches the conversion rule table CVT-D based on the values contained in the option field and the data value field of the received packet PWD to determine a packet ID to be set for a packet PWL for the wireless zone.

In the example of FIG. 10, the packet PWD received from the sensor network server SNS has a setting command that instructs, to a sensor node having a control-target global ID, an interval at which sensing data is transmitted. In the packet PWD, “setting command” is stored in the data type field, “transmission interval” is stored in the option field, “second” is stored in the unit field, and a value of “30” is stored in the data value field in the data format shown in FIGS. 6 and 7, thereby causing the target sensor node to set the transmission interval of the sensing data to 30 seconds.

As shown in FIG. 11, for example, in the downlink conversion rule table CVT-D, four setting commands are defined, in each of which a command ID for setting “second” or “minute” with respect to a transmission interval or with respect to a measurement interval for each sensor type is set in advance. In the case of FIG. 10, a packet ID of C011 is the only entry that includes “transmission interval” and “second” in the meaning interpretation conversion rule CVT-D2, so the downlink packet converting unit DPC determines C011 for the packet ID to be transmitted to the sensor node.

Next, the downlink packet converting unit DPC obtains the packet ID from the downlink conversion rule managing unit CVR-D to assembly the payload of the packet PWL for the wireless zone to be transmitted to the sensor node.

As shown in FIG. 10, when the content of the payload of the packet PWD received from the sensor network server SNS includes “transmission interval”, “second”, and “30”, for example, the downlink packet converting unit DPC sets, in the packet PWL for the wireless zone of FIG. 10, “C011” as the packet ID having 16 bits at the 0th octet and the 1st octet, and “30” in the first data field D1 having one byte at the 2nd octet.

Next, the downlink packet converting unit DPC converts the global ID of the packet PWD received from the sensor network server SNS into a corresponding local ID controlled by the base station BST. The downlink packet converting unit DPC extracts the global ID from the MAC header of the received packet PWD and inquires of the node managing unit BNDM about a local ID corresponding to the global ID.

As shown in FIG. 5, the node managing unit BNDM refers to the preset address table ADT and notifies the downlink packet converting unit DPC of the local ID.

The downlink packet converting unit DPC generates a packet PWL by setting the local ID in the MAC header of the packet PWL for the wireless zone. Next, the wireless communication control unit BRF transmits the generated packet PWL to the wireless network WLN to change the settings of the sensor node corresponding to the local ID.

The processing for a downlink packet performed by the base station BST as described above is summarized as follows. In FIG. 10, upon reception of a packet PWD from the sensor network server SNS, the wired communication control unit BNIC transmits the packet PWD to the downlink packet converting unit DPC (S11).

The downlink packet converting unit DPC extracts, from the packet PWD, values of the data type field, the option field, and the data value field, and inquires of the downlink conversion rule managing unit CVR-D about a packet ID corresponding to the setting command. The downlink conversion rule managing unit CVR-D refers to the downlink conversion rule table CVT-D and transmits the packet ID corresponding to the content (meaning information) of the setting command set in the option field to the downlink packet converting unit DPC as a response (S12).

Next, in order to convert the packet PWD for the wired zone into a packet PWL for the wireless zone, the downlink packet converting unit DPC transmits the global ID to the node managing unit BNDM to inquire of the node managing unit BNDM about a corresponding local ID (S13). Upon reception of the local ID, the downlink packet converting unit DPC sets the packet ID and the data value in the payload of the packet PWL for the wireless zone and also sets the local ID in the MAC header, thereby assembling the packet PWL. The downlink packet converting unit DPC sends the generated packet PWL to the wireless communication control unit BRF to instruct the wireless communication control unit BRF to transmit the packet PWL to the sensor node.

Therefore, the base station BST deletes meaning information from a downlink packet PWD and sends minimum information as a command to the sensor nodes SN1 to SNn. Further, the base station BST converts the global ID, which can handle any network resource on the sensor network system, into a local ID, which has a short data length and can handle any device controlled by the base station BST, to allow the packet PWL for the wireless zone to be simple and small in packet size, thereby improving the usability of the wireless network WLN, in which there are many restrictions on resources. Further, the power consumption of the sensor nodes SN1 to SNn, in which the communication time required for a packet PWL can be reduced, is suppressed, thereby enabling to ensure the lifetime of the sensor nodes SN1 to SNn.

As described above, the meaning information, with which the content of sensing data can be understood, is added in a packet PWD for the wired network WDN, so the sensing data can be easily used by multiple applications. For the wireless network WLN, the base station BST generates a simple packet PWL by deleting the meaning information from the packet PWD and transmits the packet PWL to the wireless network WLN, thereby improving the usability of the wireless network WLN.

(Communication Processing of the Sensor Node)

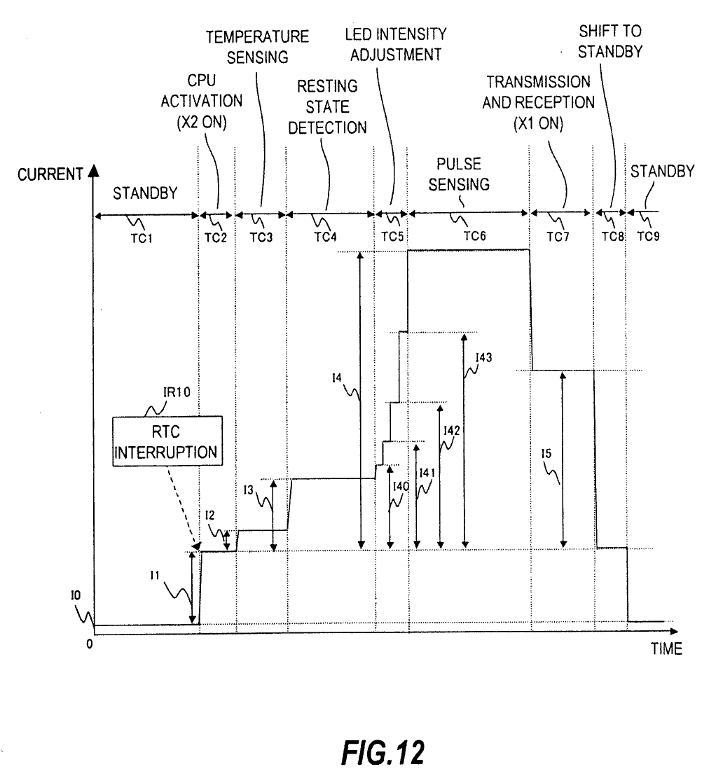

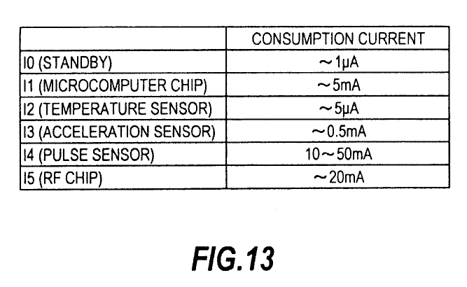

FIG. 12 is a graph showing a relationship between consumption current of the sensor node and time. A sensor node SN used in FIG. 12 is provided with a temperature sensor, an acceleration sensor, and a pulse sensor, performs sensing of the body temperature and the pulse of a wearer at predetermined measurement intervals, and transmits measurement results to the base station BST. The sensor node SN has a microcomputer chip that includes a CPU, the temperature sensor for measuring the body temperature, the acceleration sensor for detecting a resting state of the wearer, the pulse sensor configured by an LED and a light receiving element, and a wireless communication control unit (RF). FIG. 13 shows consumption current of each device of the sensor node SN.

In FIG. 12, the microcomputer chip is in a software standby mode and the consumption current is suppressed to 1 μA or below at time TC1. When a real-time clock circuit counts a predetermined measurement interval, the microcomputer chip is activated at time TC2. At time TC2, the consumption current increases to 11 (that is, 5 mA) because of the activation of the microcomputer from the standby mode.

Data is measured from time TC3 to time TC5. First, the microcomputer turns the power of the temperature sensor on and obtains a measurement value of the temperature sensor. At time TC3, the consumption current value equals to the sum of I1 and I2 because of the activation of the temperature sensor.

The temperature sensor is turned off after the body temperature is obtained, and the acceleration sensor is activated to detect the resting state at time TC4. Because of the activation of the acceleration sensor, the consumption current of the sensor node SN becomes the sum of I1 and I3 (that is, 5.5 mA) at time TC4.

The acceleration sensor is turned off if a resting state is detected, and then, at time TC5, the output of an infrared LED is gradually increased from a default value for optimization. During predetermined time TC6, pulse sensing is performed using the infrared LED and a phototransistor. During time TC6, the consumption current value becomes the maximum, that is, the sum of I1 and I4 (in a range from 15 to 55 mA).

Upon completion of the pulse sensing, the infrared LED and the phototransistor are turned off, and then driving of an RF chip is started at time TC7. During time TC7, communication is made with the base station BST to perform data transmission and command reception as described above. The consumption current becomes the sum of I1 and I5 (that is, 25 mA) during time TC7, which is the second largest consumption current.

After the transmission and reception during time TC7 ends, the RF chip is turned off. Then, at time TC8, the microcomputer chip shifts to a standby mode.

In the case of the sensor node SN, the second largest current is consumed in the time period during which wireless communication is made with the base station BST. Depending on the types of sensors mounted, there are many cases where the largest current is consumed in the time period during which wireless communication is made. Therefore, shortening the time required for wireless communication leads to an increase in lifetime of the battery of the sensor node SN. Increasing the number of cycles of battery maintenance allows the sensor node SN to be used continuously for a long period of time.

As described above, the time required for wireless communication can be reduced by reducing the data of a packet PWL for the wireless zone as much as possible. Accordingly, in the base station BST, the global ID is converted into the local ID having a short data length. Further, meaning information is deleted from a packet PWD for the wired network WDN to generate a packet PWL for the wireless network. As a result, the data length is shortened as much as possible, in other words, the data amount is reduced, thereby reducing the time required for wireless communication.

(Management of the Physical-World Model)

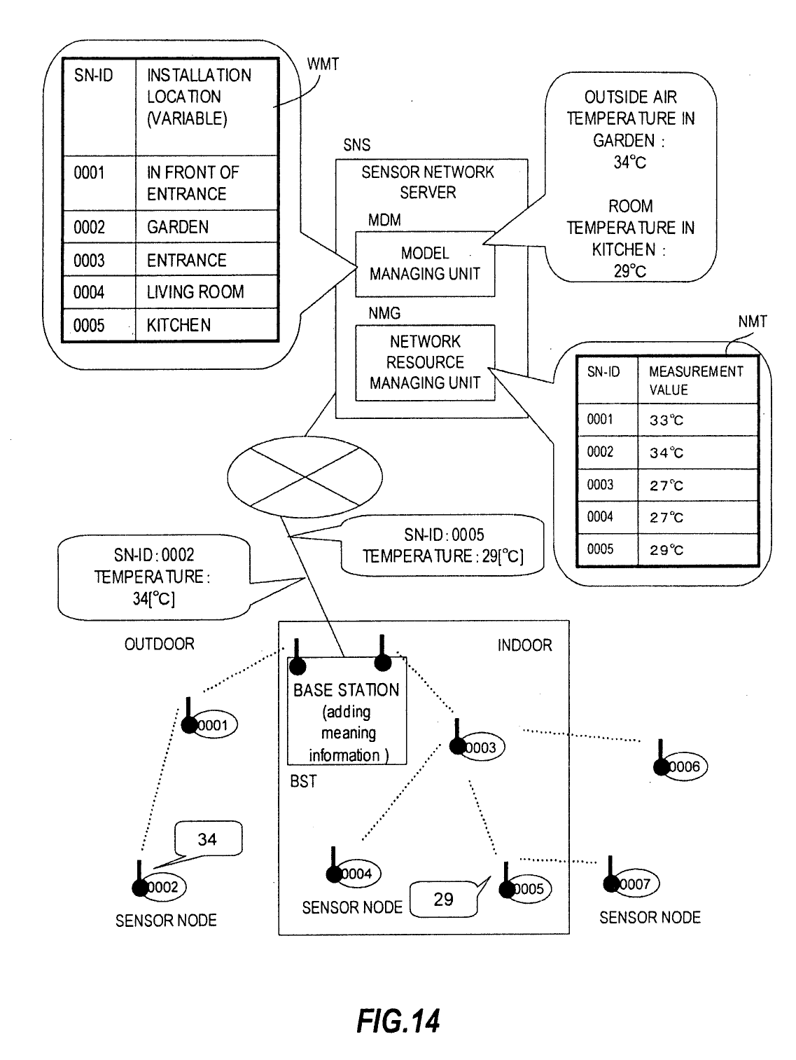

Sensing data to which meaning information is added by the base station BST as described above and which is collected in the database DB of the sensor network server SNS is managed by the network resource managing unit NMG and the model managing unit MDM of the sensor network server SNS as shown in FIG. 14. In FIG. 14, all the sensor nodes SN1 to SNn are temperature sensors.

The network resource managing unit NMG has the physical-world model table WMT used to manage the relationship between in which a sensor node ID (global ID) and the meaning (in FIG. 14, installation location) that can be understood by the user of the user terminal UST. The network resource managing unit NMG manages the relationship between a sensor node ID and the measurement value of sensing data stored in the database DB. The user terminal UST shown in FIG. 1 determines a sensor node ID whose information is to be obtained by the meaning that can be understood by the user. The model managing unit MDM inquires of the network resource managing unit NMG about a measurement value that corresponds to the determined sensor node ID, and the network resource managing unit NMG returns the measurement value whose sensor node ID matches the determined sensor node ID to the model managing unit MDM. The model managing unit MDM transmits the obtained measurement value to the user terminal UST as a response.

Sensor nodes of the same type may observe different targets and even an identical sensor node may observe different targets after the sensor node moves. Thus, it is preferred that the final meanings in the physical world be managed in the sensor network server SNS.

The base station BST adds the type of a physical quantity (for example, “temperature”) as meaning information, and the sensor network server SNS adds a target in the physical world (for example, “room temperature” or “outdoor air temperature”) as meaning information.

It should be noted that, when this invention is applied to a small-scale sensor network system, the base station BST and the sensor network server SNS may be implemented on the same device.

As described above, according to the first embodiment, the base station serving as a gateway on the sensor node side of the sensor network system adds preset meaning information to sensing data received from the wireless network WLN and transmits the resultant data to the wired network WDN, thereby making it possible to reduce the load of the wireless network WLN, where there are many restrictions on resources, and improve the usability thereof. In addition, since the data is rich in information, it becomes extremely easy to use the data in the sensor network server SNS and an application on the user terminal UST. Since the sensing data collected in the sensor network server SNS includes the meaning information added by the gateway, the sensing data can easily be used from an application on the user terminal UST without applying any process to the sensing data in the sensor network server SNS, and the development and the maintenance of the application can easily be performed. Since the meaning information is added by the gateway, the amount of data of an uplink packet transmitted in the wired network WDN is increased. However, transmission of the data rich in information can be allowed in the wired network WDN, where there are fewer restrictions on resources than the wireless network WLN.

The first embodiment has described the example where the payload having a binary format shown in FIG. 7 is used when the base station BST adds meaning information to an uplink packet received from the sensor node SN1 and transmits the packet to the wired network WDN. However, the data format of the payload is not limited thereto. The payload may include the data type, the type and the unit of a physical quantity, a measurement value, and a structure which are written in text using XML or the like.

The first embodiment has described the example where the downlink packet converting unit (second data converting unit) DPC of the base station BST always applies conversion processing to a downlink packet. However, if a command having a small amount of data is received from the sensor network server SNS, the command may be transmitted to the sensor nodes SN1 to SNn without performing the conversion processing. Alternatively, the downlink packet converting unit DPC of the base station BST may monitor the amount of data of a command received from the sensor network server SNS, and when the command has a small amount of data (data amount less than a predetermined threshold), the command may be transmitted to the sensor nodes SN1 to SNn without performing the conversion processing.

Further, the first embodiment has described the example where sensing data is stored in the database DB of the sensor network server SNS. However, the database DB may include data storage in a memory in addition to storing data in a so-called file system.

Further, the first embodiment has disclosed the example of the base station BST serving as the gateway. The function of the gateway of this invention may be provided for a cellular phone and an RF tag reader communicating with an RFID tag.

### Second Embodiment

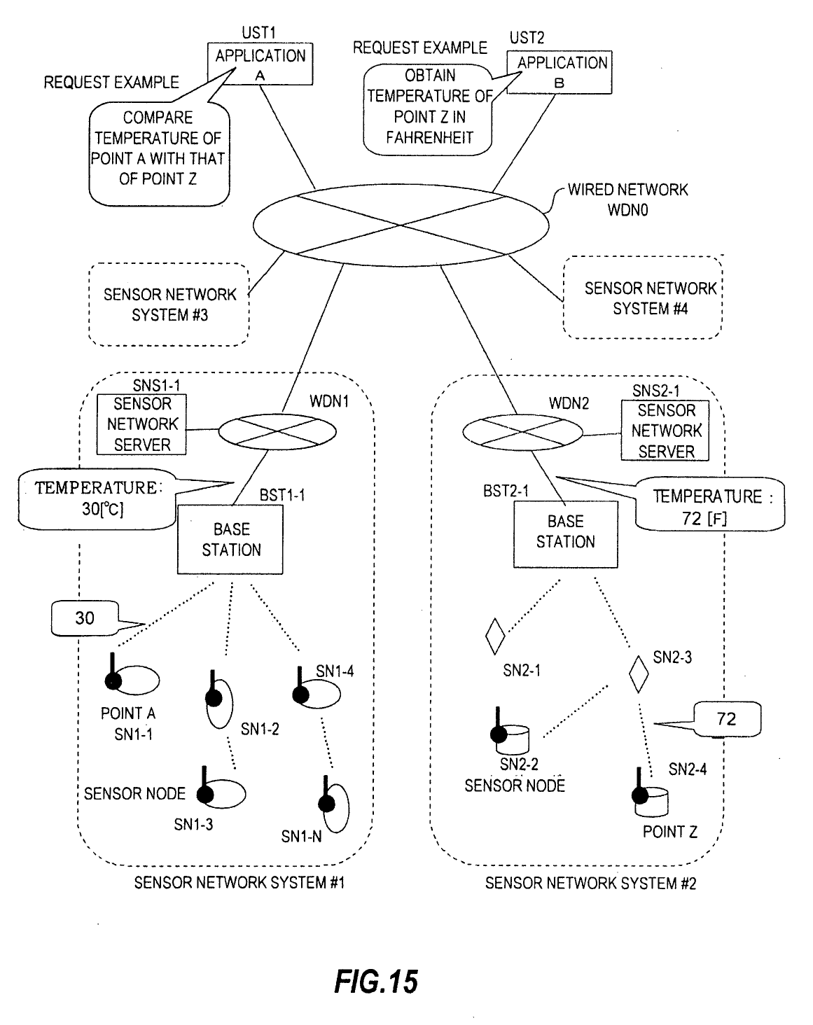

FIG. 15 shows an example of using sensing data by a large number of sensor network systems, according to a second embodiment.

A wired network WDN0 is connected to multiple user terminals UST1 and UST2 and to multiple sensor network systems # 1 to #4. The user terminal UST1 runs an application A that uses sensing data of the multiple sensor network systems # 1 to #4. The user terminal UST2 runs an application B that uses the sensing data of the multiple sensor network systems #1 to #4.

A sensor network system #1 is configured in the same way as the sensor network system of the first embodiment, in which a sensor network server SNS-1 is connected to a base station BST1-1 via a wired network WDN1 and there are a large number of sensor nodes SN1-1 to SN1-N controlled by the base station BST1-1. As in the first embodiment, the base station BST1-1 adds meaning information to an uplink packet PWD destined for the sensor network server SNS-1 and also adds a global ID, which can be identified even by the sensor network systems #1 to #4, to the uplink packet PWD. The base station BST1-1 deletes the meaning information from a downlink packet PWL destined for the sensor nodes SN1-1 to SN1-N, adds to the packet PWL a packet ID having a shorter data length instead, and further assigns to the packet PWL a local ID having a short data length instead of the global ID. The sensor nodes SN1-1 to SN1-N each include a temperature sensor.

The other sensor network systems #2 to #4 are each configured in the same way as the sensor network system #1. The sensor network systems #2 to #4 each include a sensor network server SNS, a base station BST, and sensor nodes SNn each having a temperature sensor.

The unit of measure for temperature is “° C.” (Celsius) in the sensor nodes SN1-1 to SN1-N of the sensor network system #1, whereas that is “° F.” (Fahrenheit) in the sensor nodes SN2-1 to SN2-N of the sensor network system #2.

The application A of the user terminal UST1 compares the temperature at a point A measured by the sensor node SN1-1 of the sensor network system #1 with the temperature at a point Z measured by the sensor node SN2-4 of the sensor network system #2.

The application A requests the sensor network server SNS1-1 for the sensing data of the point A and also requests the sensor network server SNS2-1 for the sensing data of the point Z. It should be noted that, in each sensor network server SNS, the model managing unit MDM determines the relationship between the point A, Z and the sensor node, as in the first embodiment.

The application A analyzes packets PWDs read from the sensor network servers SNS1-1 and SNS2-1 and obtains the type and the unit of a physical quantity from each option field shown in FIG. 7. The application A judges that pieces of the sensing data obtained from the sensor network systems #1 and #2 indicate the same type of a physical quantity, i.e., “temperature”, but differs in the unit systems thereof. Specifically, “° C.” is used in the sensor network system #1 whereas “F” is used in the sensor network system #2. The application A can convert one of the two different unit systems into the other (for example, ° C.) according to a logic provided in advance so as to compare the temperatures at the two points A and Z.

As described above, even in the case where the sensor network systems #1 to #4 handle the same type of a physical quantity but different unit systems, the difference of the unit systems can be accurately judged by referring to the meaning information (the type and the unit of a physical quantity) added by the base station BST, and the comparison can be performed after conversion to any one of the unit systems.

The application B of the user terminal UST2 measures the temperature of the sensor network system #2. Specifically, the application B measures the temperature at the point Z in response to an instruction of the user and displays the temperature in Fahrenheit. The application B requests the sensor network server SNS2-1 of the sensor network system #2 for sensing data of the sensor node SN2-4 located at the point Z.

The application B analyzes a packet PWD read from the sensor network server SNS2-1 and obtains the type and the unit of a physical quantity from the option field shown in FIG. 7. The type and the unit of a physical quantity of the sensing data obtained from the sensor network server SNS2-1 are “temperature” and “F”, respectively, so the application B judges that there is no need to convert the data value and then displays the data value “72” as it is.

As described above, by using the meaning information (the type and the unit of a physical quantity) added by the base station BST, the application B, which uses sensing data, can properly use the data value of any sensor node SN.

In a case where pieces of sensing data of the multiple sensor network systems #1 to #4 are used by the user terminals UST1 and UST2, when packets PWDs to be transmitted from the base stations BST1-1, BST2-1, and the like to the wired networks WDN1, WDN2, and the like, respectively, are made to have a common data format, the enormous amount of sensing data can be efficiently used. Since the common data format is used, the development and the maintenance of an application become extremely easy.

On the other hand, in the sensor nodes SN1-1 to SN1-N and SN2-1 to SN2-N controlled by the base stations BST1-1 and BST2-1, respectively, packets PWLs for the wireless zone are not required to have a data format common to the sensor network systems #1 to #4. The data format can be appropriately specified in each sensor network system according to the property of each sensor node or the like. Thus, the architecture of the sensor network system can be configured as desired.

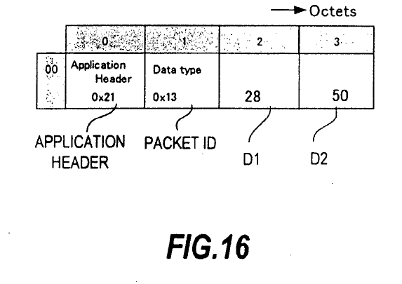

In addition, as shown in FIG. 16, when the data format of a packet PWL for the wireless zone includes two levels for a packet ID, and an application identifier (application header) is included in the first level, the ID other than the application identifier can be assigned as desired for each application, so the management of IDs becomes easy.

As described above, this invention can be applied to a sensor network system that performs wireless communication between a sensor node and a base station and wired communication between the base station and a server.

While the present invention has been described in detail and pictorially in the accompanying drawings, the present invention is not limited to such detail but covers various obvious modifications and equivalent arrangements, which fall within the purview of the appended claims.

1.-15. (canceled)

16. A method for transferring data of a sensor network system in which communication is made with multiple sensor nodes connected to the sensor network system via a wireless network to transmit sensing data measured by each of the multiple sensor nodes to a server via a wired network, the method comprising the steps of:
receiving the sensing data from each of the multiple sensor nodes;
adding meaning information that corresponds to a measurement value contained in the sensing data to the sensing data; and
transmitting the sensing data to which the meaning information is added to the server.

17. The method for transferring data of a sensor network system according to claim 16, wherein the step of adding meaning information that corresponds to a measurement value contained in the sensing data to the sensing data comprises the steps of:
extracting a data identifier specified by the sensor node from the sensing data received from the sensor node;
retrieving the meaning information of the sensing data which corresponds to the data identifier from a preset data conversion table; and
adding the retrieved meaning information to the sensing data.

18. The method for transferring data of a a sensor network system according to claim 17, wherein:
the data conversion table associates a type of a physical quantity of the sensing data which corresponds to the data identifier with a unit of the physical quantity; and
the type and the unit of the physical quantity are added to a measurement value contained in the sensing data.

19. The method for transferring data of a a sensor network system according to claim 16, wherein the step of adding meaning information that corresponds to a measurement value contained in the sensing data to the sensing data comprises the steps of:
converting a local ID contained in the sensing data received from each of the multiple sensor nodes into a corresponding global ID uniquely identifiable on the wired network; and
specifying the global ID in the sensing data in place of the local ID.

20. The method for transferring data of a a sensor network system according to claim 16, further comprising the step of transmitting a command received from the server to a corresponding sensor node,
wherein the step of transmitting to a corresponding sensor node comprises the steps of:
extracting meaning information contained in the command received from the server;
retrieving a data identifier corresponding to the meaning information from a preset data conversion table; and
deleting the meaning information from the command and specifying the data identifier in the command.

21. The method for transferring data of a a sensor network system according to claim 16, further comprising the step of transmitting a command received from the server to a corresponding sensor node,
wherein the step of transmitting to a corresponding sensor node comprises the steps of:
converting a global ID contained in the command received from the server into a corresponding local ID uniquely identifiable on the wireless network; and
specifying in the command the local ID, which has a smaller amount of data than the global ID, in place of the global ID.
